(19) United States
(12) Patent Application Publication
(10) Pub. No.: US 2014/0327694 A1
(43) Pub. Date: Nov. 6, 2014

(54) Simultaneous Display of Multiple Content Items

(71) Applicants: Xiang Cao, Beijing (CN); Seokhwan Kim, Tsukuba (JP); Haimo Zhang, Singapore (SG); Desney S. Tan, Kirkland, WA (US)

(72) Inventors: Xiang Cao, Beijing (CN); Seokhwan Kim, Tsukuba (JP); Haimo Zhang, Singapore (SG); Desney S. Tan, Kirkland, WA (US)

(73) Assignee: Microsoft Corporation, Redmond, WA (US)

(21) Appl. No.: 13/518,620

(22) PCT Filed: Jan. 19, 2012
(86) PCT No.: PCT/CN12/70572

§ 371 Date: Jun. 22, 2012

(51) Int. Cl. G09G 5/14; G06T 11/00; G09G 5/02

(52) U.S. Cl. CPC G09G 5/14; G09G 5/02; G06T 11/001; G09G 2340/06; G06T 2200/28; G09G 2320/068
USPC 345/597; 345/617; 345/589

(57) ABSTRACT

Techniques for presenting multiple content items on a display without hardware modification. These techniques determine a first angle relative to the display at which a first content item is to be shown and a second content item is to be hidden. The techniques also determine a second angle at which the first content item is to be hidden and the second content item shown. The techniques then compute a first pair of pixel values having a contrast that is less than a threshold at the first angle and a second pair of pixel values having a contrast that is less than the threshold at the second angle. The techniques then render the content items such that the first content item is perceivable at the first angle and hidden at the second angle, while the second content item is hidden at the first angle and perceivable at the second angle.

### PRIORITY APPLICATION

This application is a 35 U.S.C. 371 National Stage Entry of and claims priority to PCT Application Serial No. PCT/CN2012/070572, entitled “Simultaneous Display of Multiple Content Items,” filed on Jan. 18, 2012, which is fully incorporated by reference herein.

### BACKGROUND

Researchers have recently explored a variety of technologies that enable a single display to simultaneously present different content when viewed from different angles or by different people. These displays provide new functionality such as personalized views for multiple users, privacy protection, and stereoscopic 3D displays. However, current multi-view displays rely on special hardware, thus significantly limiting their availability to consumers and adoption in everyday scenarios.

### SUMMARY

This document describes, in part, techniques for presenting multiple content items (e.g., images, videos, etc.) on a display without hardware modification to the display or an associated computing device. In some instances, the techniques determine a first angle relative to the display at which a first content item is to be shown and at which a second content item is to be hidden. The techniques may also determine a second angle relative to the display at which the first content item is to be hidden and at which the second content item is to be shown. The techniques then compute a first pair of pixel values having an observed contrast that is less than a threshold at the first angle and a second pair of pixel values having an observed contrast that is less than the threshold at the second angle.

The techniques may then render the first and second content items on the display by multiplexing pixel values of the first content item (based on the first pair of pixel values) with pixel values of the second content item (based on the second pair of pixel values). As such, the first content item is perceivable at the first angle and hidden at the second angle, while the second content item is hidden at the first angle and perceivable at the second angle.

This summary is provided to introduce concepts relating to simultaneous display of multiple different content items. These techniques are further described below in the detailed description. This summary is not intended to identify essential features of the claimed subject matter, nor is it intended for use in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to reference like features and components.

FIG. 1 illustrates an example scenario where a display renders a first content item that is perceivable to a first user viewing the display at a first angle, while being unperceivable to a second user viewing the display at a second, different angle. In addition, this example scenario includes the display rendering a second content item that is perceivable to the second user at the second angle, while being unperceivable to the first user at the first angle. As such, the two users are able to view to different content items simultaneously on a single display.

FIG. 2 illustrates example color channel brightness curves in both the vertical and horizontal orientations for a particular type of display. As described below, these curves may be utilized to identify pixel values used for rendering content items that are perceivable at one angle relative to a display and unperceivable at another angle relative to the display.

FIG. 3 is an example flow diagram of a process for rendering first and second content items on a common display without hardware modification to the display or an associated computing device. This process includes computing pixel-value pairs having respective contrasts that are less than a threshold at respective angles, identifying pixel values to render based on these pixel-value pairs, and rendering the first and second content items using the identified pixel values.

FIG. 4 is an example flow diagram of two different example processes for identifying the pixel values to render for the first and second content items based on the computed pixel-value pairs.

FIG. 5 is an example flow diagram of two different example processes for rendering the first and second content items. The first example process spatially multiplexes pixel values of the first and second content items, while the second example process temporally multiplexes these pixel values.

FIG. 6 illustrates several example components that may reside on a computing device for computing pixel values to enable simultaneously rendering of multiple content items, as illustrated in FIG. 1. In some instances, the device computes these pixel values with reference to multiple color channel brightness curves that are associated with the display that will render the content items.

### DETAILED DESCRIPTION

This document describes, in part, techniques for presenting multiple content items (e.g., still images, videos, etc.) on a display without hardware modification to the display or an associated computing device. The display may comprise a liquid crystal display (LCD), such as a twisted nematic LCD (TN LCD), a vertical alignment LCD (VA LCD), an in plane switching LCD (IPS LCD), or any other type of display that supports the techniques for presenting multiple content items as described herein. In the example of a TN LCD, the techniques described herein may present the multiple content items by exploiting a technical limitation of the technology that causes these LCDs to show varying brightness and color depending on an angle at which a user views the display. The following discussion describes these techniques in further detail, as well as example usage applications for these techniques.

As discussed briefly above, multi-view display devices that are capable of presenting two or more different views concurrently for different viewing angles and/or different viewers have attracted increasing attention in recent years. Such displays may support multiple people viewing personalized information, protect private information from bystanders, or enable natural stereo 3D viewing experiences. To support these applications, a variety of multi-view display technologies have surfaced, some that require viewers to wear special glasses as selective filters, and others that focus on special optical designs to manipulate light routes so as to present varying information in different directions.

Despite the appeal of these technologies, their requirement for specialized (and often expensive and cumbersome) display hardware has limited their adoption by general consumers for use in daily scenarios. To address this challenge, the techniques described below present a solution that may be implemented in pure software in some implementations. This solution enables two independent views from different viewing angles without hardware modification or augmentation. This solution can be employed on, TN LCDs, for example, with no additional cost, thus potentially supporting multi-view display scenarios for everyday use.

In order to enable these multi-view applications, the techniques described herein deliberately exploit a limitation of the TN LCD technology, namely that the observed brightness and color of these LCDs vary when viewed from different angles. This well-known effect results in the LCDs' so-called “narrow view” and is generally deemed as a drawback of TN LCD technology. However, by carefully examining the characteristics of such changes, the techniques intentionally manipulate the pixel colors of an image so that the observed contrast of the image is maximized or minimized, effectively showing or hiding it, at different viewing angles. By spatially or temporally multiplexing two such images optimized for alternate angles, the techniques are able to display two independent views concurrently, each for a different viewing angle.

The discussion begins with an “Overview” section that describes, at a high level, the techniques for simultaneously displaying two content items on a common display. This section also discusses certain display principles and characteristics that may enable this concurrent display. The discussion then moves to a section entitled “Example Operation”, which illustrates and describes several processes for implementing the techniques. Next, a section entitled “Example Computing Device” illustrates example components of a device that may be configured to compute pixel values for rendering two content items simultaneously on a common display. The discussion then proceeds to sections entitled “Measuring Brightness Curves” and “Example Applications”, before ending with a brief “Conclusion”. This brief introduction, including section titles and corresponding summaries, is provided for the reader's convenience and is not intended to limit the scope of the claims, nor the proceeding sections.

### Overview

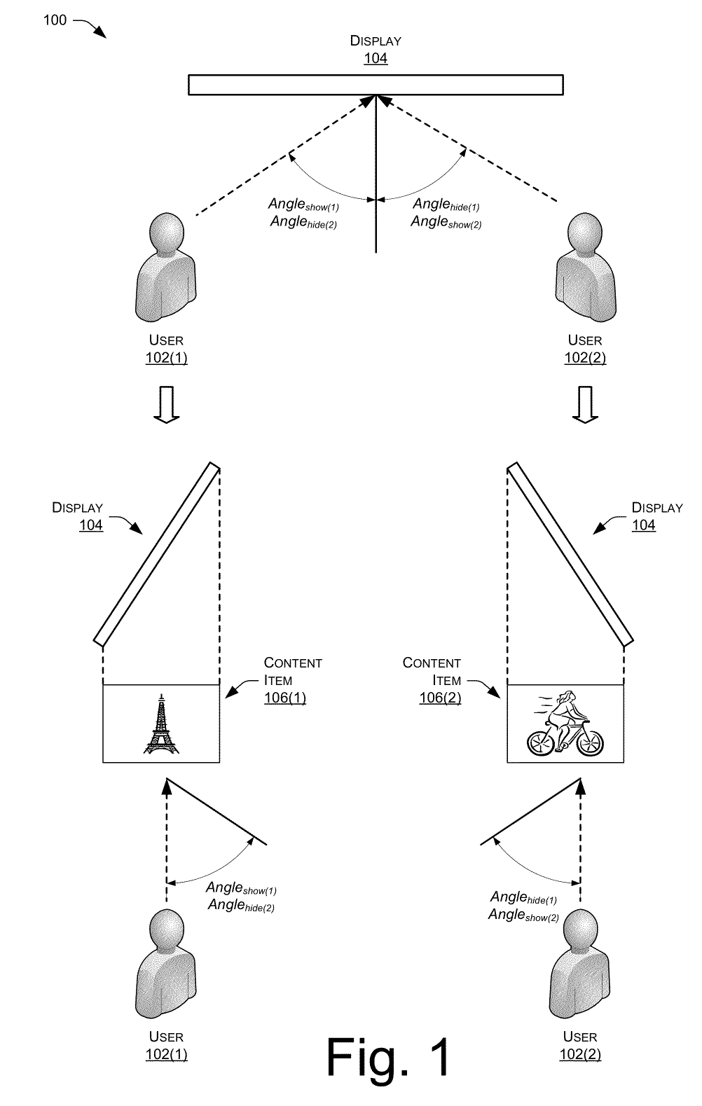

FIG. 1 illustrates an example scenario 100 where a first user 102(1) views a display 104 at a first angle relative to the display 104 (angle_{show (1)}, angle_{hide (2)}), while a second user 102(2) views the display 104 at a second angle relative to the display 104 (angle_{show (2)}, angle_{hide (1)}). In this example, the display 104 renders a first content item 106(1) that is viewable to the first user 102(1) and hidden to the second user 102(2), as well as a second content item 106(2) that is viewable to the second user 102(2) and hidden to the first user 102(1). The display 104 may render these content items by spatially or temporally multiplexing the content items on the display 104.

As the example scenario 100 illustrates, the display 104 renders the first content item 106(1) such that this content item is perceivable at a particular angle (angle_{show(1)}) while hidden at a second, different angle (angle_{hide(1)}). In addition, the display 104 renders the second content item 106(2) such that this content item is perceivable at another particular angle (angle_{show (2)}) while hidden at another second, different angle (angle_{hide2}). As such, the user 102(1) is able to view the first content item 106(1) while the second user is able to view the second content item 106(2). While this example illustrates the hide angle of each content item corresponding to the show angle of the other content item, in other examples these angles may differ. In either case, the techniques are effective to allow different users to view different content items simultaneously on the common display 104.

As discussed above, certain principles and characteristics of LCDs (e.g., TN LCDs) enable the simultaneous display of the different content items 106(1) and 106(2). As is known, an LCD comprises of a matrix of liquid crystal (LC) molecules between two polarizers, with a uniform backlight residing beneath these polarizers. These two polarizers are polarized in perpendicular directions so that, by default, the backlight does not pass through. However, when the polarized light coming from the first polarizer passes through the LC matrix, its polarization direction rotates according to the direction of the LC molecules, making it no longer perpendicular to that of the second polarizer. Thus the resulting light is able to pass through the second polarizer. The exact amount of light passing through is dependent on the angle between the LC molecules and the two polarizers. Varying the voltage applied to the LC molecules controls their direction, and in turn the light intensity eventually emitted from the display. Extending this principle, each screen pixel consists of three color filters (red (R), green (G), and blue (B)) and three independently controlled groups of LC molecules for producing various colors.

Depending on the specific type of LCD technology, the LC molecules are rotated in different fashions. In particular, in TN LCDs, the LC molecules are rotated within a plane perpendicular to a plane of the display. Because of this, when a viewer looks at the display from different angles, the line of sight (hence the line of light transmission) is also at different angles with regard to the direction of the LC molecules. This results in the light polarization directions being rotated differently by the LC molecules, leading to different light intensities emitted from the same pixel to different angles. In addition, because R, G, and B lights respond to the LC molecules slightly differently, this may also result in color shift. These effects cause the well-known phenomenon known as “narrow view”, indicating the varying brightness and color of these LCDs depending on a viewing angle of a user. In some instances, the techniques described herein may apply to LCDs and/or any other type of display exhibiting the characteristics or principles discussed above.

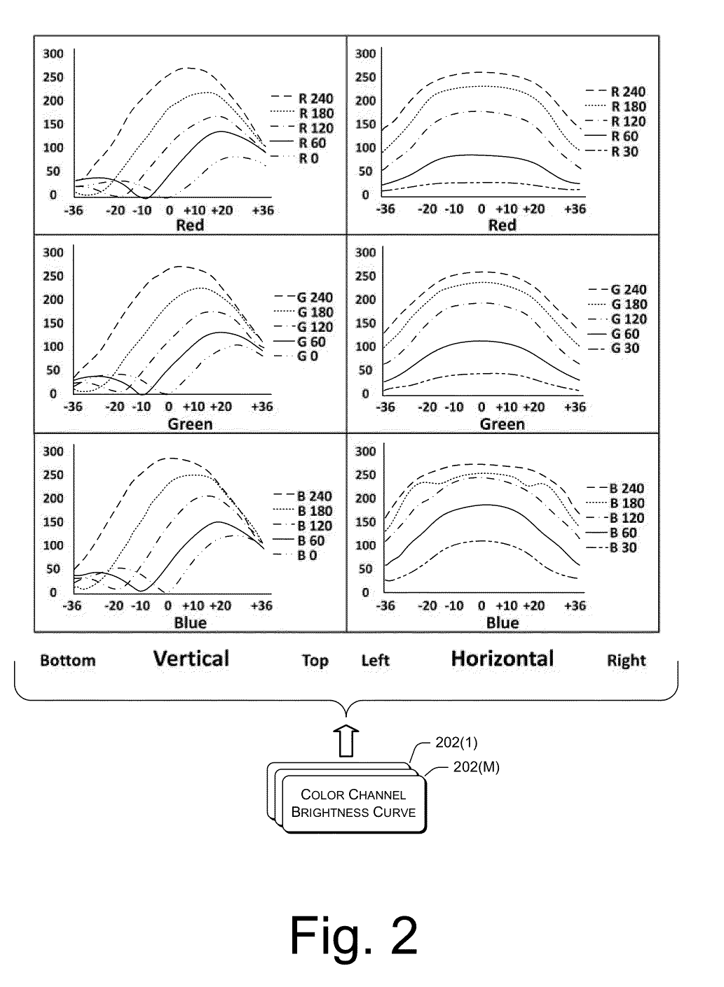

FIG. 2 illustrates example color channel brightness curves 202(1), . . . , 202(M) on a per-color-channel basis in both the vertical and horizontal orientations for a particular type of display (here, a particular type of TN LCD). In these example curves 202(1)-(M), the X-axis represents the viewing angle and the Y-axis represents observed image brightness. As such each brightness curve represents a different pixel value from 0-255 being displayed (e.g., R 240 means a pixel value of RGB (240, 0, 0), etc.). The Y-coordinate of the curve at 0° represents the “true” brightness seen from the front of the display. As will be appreciated, FIG. 2 illustrates several representative curves for example pixel values. Of course, while FIG. 2 illustrates several example curves, it is to be appreciated that the techniques described herein may utilize more, fewer, and/or different curves in other implementations. Furthermore, these curves may be obtained in any manner, such as by using the techniques described below in the section entitled “Measuring Brightness Curves” or otherwise.

In this example, the LCD corresponding to the curves 202(1)-(M) was measured while placed statically in a landscape orientation. For vertical viewing angles, negative angles correspond to viewing the display from the bottom and upwards towards the display (denoted as “bottom views”) and positive angles correspond to viewing the display from the top and downwards onto the display (“top views”). As a precaution for potential confusion, note that in situations of a laptop with a tilt-able display and a viewer sitting statically in front of the display, bottom views are observed when the display is tilted facing upwards, and top views are observed when the display is tilted facing downwards. Of course, while a laptop display is discussed, it is to be appreciated that the techniques may apply across any other type of display device (e.g., television monitors, mobile phone displays, desktop computer monitors, etc.).

Similarly, for horizontal viewing angles, negative angles correspond to viewing the display from the left and positive angles correspond to viewing the display from the right. As the example curves 202(1)-(M) illustrate, each of the R, G, and B channel curves generally follows the same trend, with slight differences in the exact numbers. Furthermore, although these curves 202(1)-(M) correspond to a particular LCD, the trends of these curves may generalize to an array of different displays (e.g., TN LCDs), although the exact numbers may vary between devices.

As illustrated in the example curves 202(1)-(M), the vertical viewing angles show may show more dramatic changes in light intensity than do the horizontal viewing angles. In the instance of LCDs, this may attribute to the fact that when the line of sight is within the same plane as the LC molecule rotation, the angle between these two also changes dramatically along with the viewing angle, while when the line of sight is perpendicular to the rotation plane, the correlation is less drastic. LCD manufactures usually set the LC molecule rotation plane to optimize for a “wider view” horizontally as this is the direction in which viewers are more likely to be moving or distributed.

### Example Operation

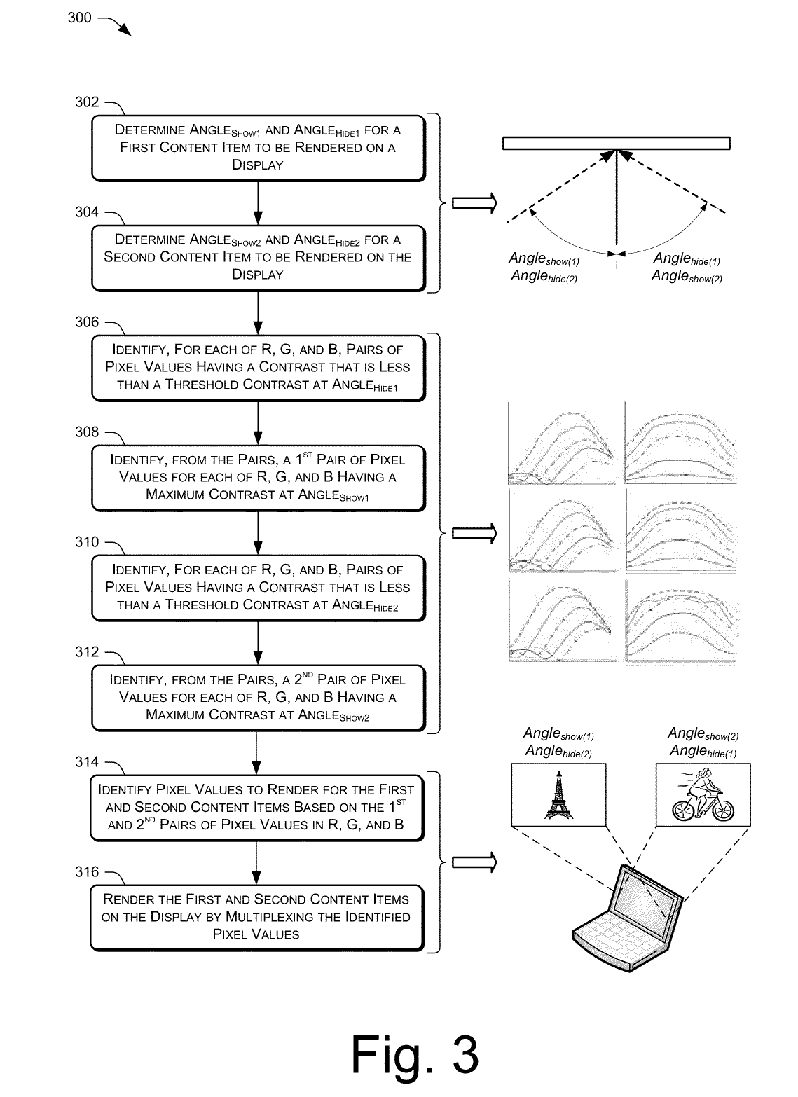

FIG. 3 is an example flow diagram of a process 300 for rendering first and second content items on a common display without hardware modification to the display or an associated computing device, given the display characteristics discussed immediately above. This process 300 (as well as each process described herein) is illustrated as a collection of acts in a logical flow graph, which represents a sequence of operations that can be implemented in hardware, software, or a combination thereof. In the context of software, the blocks represent computer instructions stored on one or more computer-readable media that, when executed by one or more processors, perform the recited operations. Note that the order in which the process is described is not intended to be construed as a limitation, and any number of the described acts can be combined in any order to implement the process, or an alternate process. Additionally, individual blocks may be implemented in parallel with one another or deleted altogether from the process without departing from the spirit and scope of the subject matter described herein.

At 302, the process 300 determines an angle at which a first content item is to be shown (angle_{show(1)}) as well as an angle at which the first content item is to be hidden (angle_{hide(1)}). In some instances, the process 300 determines these angles by receiving an input from a user specifying the angles. In addition, at 304, the process 300 determines an angle at which a second, different content item is to be shown (angle_{show(2)}) as well as an angle at which the second content item is to be hidden (angle_{hide(2)}). As discussed above, in some instances angle_{show(1)} may correspond to angle_{hide(2)}, while angle_{show(2)} may correspond to angle_{hide(1)}.

In general, in order to show a respective content item at angle_{show} and hide the content item at angle_{hide}, the content item may consist of pixel colors that maximize their observed contrast at angle_{show} and at the same time have an observed contrast at angle_{hide} that is below a threshold, t, of perceivable contrast. Hence the process 300 may seek to locate such a combination of pixel colors on a given LCD for a given pair of angles, angle_{show} and angle_{hide}. Note that this contrast can be conveniently represented as the difference between observed brightness values, which may also be equivalently converted to the contrast ratio in terms of luminance via a logarithmic relationship in some instances.

As such, at 306, the process 300 identifies, for each of R, G, and B, pairs of pixel values having a contrast that is less than the threshold at angle_{hide(1)}. At 308, and as discussed in further detail below, the process 300 then identifies, from the pixel-value pairs that are less than the threshold at angle_{hide(1)}, the pixel-value pair having the greatest contrast at angle_{show(1)}. At 310, meanwhile, the process 300 may similarly identify, for each of R, G, and B, pairs of pixel values having a contrast that is less than the threshold at angle_{hide(2)}. At 312, the process 300 then identifies, from the pixel-value pairs that are less than the threshold at angle_{hide(2)}, the pixel-value pair having the greatest contrast at angle_{show(2)}.

In order to identify the first and second pairs of pixel values at 308 and 312, respectively, the techniques may take a divide-and-conquer approach for each pair. That is, the techniques may first focus on enabling the showing and hiding each respective content item consisting of a single color channel (R, G, or B). In this regard, the curves 202(1)-(M) in this example indicate that over the range of the negative vertical viewing angles, multiple curves intersect with one another. Each intersection of two curves indicates that these two corresponding pixel color values may appear exactly the same from this viewing angle and, thus, can be used to hide the content item. On the other hand, each pair of the curves 202(1)-(M) also diverges quickly beyond the intersection point, meaning they are indeed capable of showing the image at other angles. Similarly, many curves converge quickly when the vertical viewing angle moves towards larger positive angles, which are also promising candidates for hiding information at these angles. On the contrary, in this example the curves 202(1)-(M) in the horizontal viewing angles are roughly parallel and do not intersect, meaning it might be difficult to hide an image by changing the horizontal viewing angle for this example display device. As discussed above, this may be because the example LCD has been optimized for maintaining more visibility in horizontal viewing angles.

Of course, it is to be appreciated that the curves 202(1)-(M) are merely example curves, and that other display devices may be associated with intersecting curves in the horizontal and/or vertical orientation. Furthermore, some display devices (e.g., desktop monitors, tablet or Slate computing devices, ebooks, smart phones, Microsoft Surface Computers, etc.) may be rotatable, such that a user may physically rotate, or perform an action to initiate the rotation of the display view from a landscape orientation to a portrait orientation, or vice versa, to utilize the techniques described herein.

Returning to the process 300, the techniques find the first pair of pixel values in a single color channel (R, G, or B) using an automatic algorithm that takes the angle_{show(1)}, the angle_{hide(1)}, the contrast threshold (t), and the brightness curves for the color channel of the particular LCD as input. The algorithm first searches for each possible pair of pixel values that have an observed contrast (i.e., difference in observed brightness) that is less than t at angle_{hide(1)}. Then, among these pairs, the algorithm searches for and selects the pair that has the largest observed contrast at angle_{show(1)}.

In addition, the process 300 may utilize the same approach for finding the second pair of pixel values, using the angle_{show(2)}, the angle_{hide(2)}, the contrast threshold (t), and the brightness curves for the color channel of the particular LCD as input. This threshold may comprise any threshold at which the contrast between two pixel values is unperceivable to a human user (e.g., zero, one, five, ten, etc.). Furthermore, while this example utilizes the same threshold for the first and the second pairs of pixel values, in other instances the process 300 may utilize different respective thresholds when locating these pixel-value pairs.

As described above, the pixel value pairs may be found by the algorithm using the curves 202(1)-(M). The following table (Table 1) lists example values and their respective observed brightness at two example angles in one example color channel (G), where Pair a is used to render the first content item to be shown the image at +25° and hidden at −25°, and Pair b is used to do the opposite. Similarly, Pair a′ may be used to show the first content item at +10° and hide it at −10°, and Pair b′ may be used for the opposite.

TABLE 1

| | | Pair a | | | Pair b | | |
|---|---|---|---|---|---|---|---|
| | | | | Observed | | | Observed |
| Pixel Value (G) | | 1 | 190 | contrast | 202 | 255 | contrast |
| Observed | +25° | 96 | 166 | 70 | 163 | 173 | 10 |
| Brightness | | | | | | | |
| Observed | −25° | 35 | 328 | 3 | 23 | 138 | 115 |
| Brightness | | | | | | | |
| | | Pair a′ | | | Pair b′ | | |
| | | | | Observed | | | Observed |
| Pixel Value (G) | | 1 | 105 | contrast | 241 | 255 | contrast |
| Observed | +10° | 59 | 133 | 74 | 233 | 244 | 10 |
| Brightness | | | | | | | |
| Observed | −10° | 27 | 32 | 5 | 198 | 234 | 36 |
| Brightness | | | | | | | |

In addition to hiding the first content item and the second content item at the angle_{hide(1)} and the angle_{hide(2)}, respectively, the respective content items may also remain hidden in nearby viewing angles where the observed contrast remains unperceivable to a human user. The range of this neighborhood may vary by device and by the angle_{hide} itself, and may be between 5-10° in some instances.

After identifying the first pair of pixel values and the second pair of pixel values at 308 and 312, respectively, the process 300 may identify, at 314, pixel values to render for the first and second content items based on these first and second pairs of pixel values. That is, the process 300 may use the pixel-value pairs along with the original pixel values of each content item to determine what pixel values to render when displaying the first and second content items.

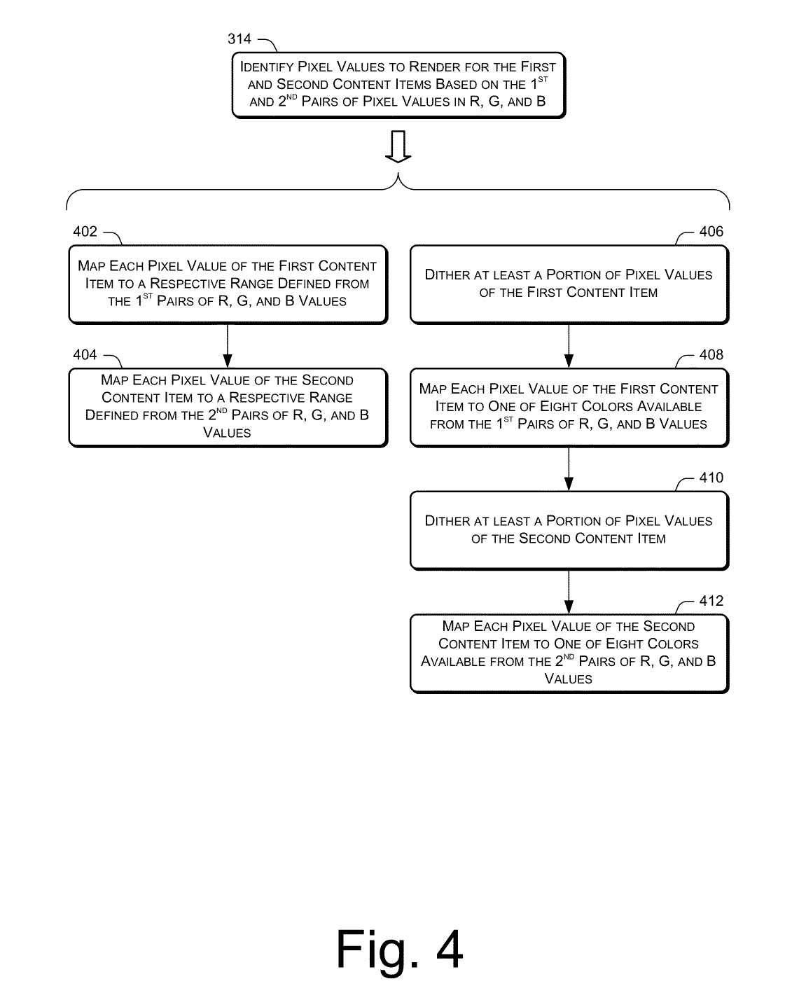

FIG. 4 illustrates two different manners in which the techniques may identify these pixel values at 314. First, the process 300 may, at 402, map each original pixel value of the first content item into a respective range defined from the first pairs of pixel values in the R, G, and B channel. For instance, the process 300 may linearly interpolate the original pixel values of the first content item from the range 0-255 onto the range defined by the first pair of pixel values selected above. The process 300 may also map each original pixel value of the second content item into a respective range defined from the second pairs of pixel values in the R, G, and B channel at 404. Again, the process 300 may linearly interpolate the original pixel values of the second content item from the range 0-255 onto the range defined by the second pair of pixel values selected above.

In this regard, analysis of the example curves 202(1)-(M) in FIG. 2 reveals that although each pair of curves may intersect at a different point, in general neighboring curves intersect at neighboring positions both in terms of viewing angle and in terms of observed brightness. This suggests that if instead of using the optimal pixel value pair found for the respective angle_{show} and angle_{hide}, the techniques use the continuous range of values between the respective pairs, then the observed contrast may still be low enough to hide the respective content item. To do so, the techniques take an existing grayscale content item (e.g., static image, frame of a video, etc.) and perform a linear transform of its pixel values to envelop them between the respective pair of pixel values in the R, G, or B color channel, so that the original maximal pixel value maps to the higher value in the pair, and vice versa. The techniques may utilize the following example equation when mapping the pixel values in the manner discussed at 402 and 404:

Pixel_{render}=Pairₘᵢₙ+[(Pixel_{orignal}−Orignalₘᵢₙ)(Pairₘₐₓ−Pairₘᵢₙ)]÷(Originalₘₐₓ−Originalₘᵢₙ) (1)

In this equation, Pairₘᵢₙ and Pairₘₐₓ are the lower and higher value in the optimal pair in the respective color channel, Originalₘᵢₙ and Originalₘₐₓ are the minimal and maximal pixel values in the original image, and Pixel_{original} and Pixel_{render} are the original and rendered value for each pixel. By mapping pixel values in this manner, the techniques are able to display more subtle details of a respective content item, while at the same time still hiding the content item at the respective angle_{hide}. Furthermore, while use of equation (1) takes into account the minimal and maximal pixel values in the original image, in other instances the pixel values may be interpolated in another manner. For instance, the techniques may map pixel values of 0-255 to Pairₘᵢₙ and Pairₘₐₓ regardless of the minimal and maximal pixel values of the original image. In these instances, the contrast may be slightly less, but the rendered result may be more consistent between different images. Of course, while several examples are provided, it is to be appreciated that the techniques may interpolate pixel values onto a continuous color range in any other manner.

Furthermore, as the R, G, B color channels are perceived independently by human (as well as by cameras), the techniques may combine these color channels to enable the showing and hiding of colored content items. Taking an arbitrary colored content item as input, for each one of its three color channels, the techniques may separately and independently determine the rendered pixel values, either as discussed above or as discussed immediately below, and remix the three rendered channels into the resulting colored content item.

Alternatively, combining the optimal pairs for each color channel in this manner, the techniques may display a collection of eight colors (2×2×2) in total (approximately red, green, blue, yellow, cyan, magenta, black, and white) at a respective angle_{show}, which may be sufficient for many applications. To further increase the color expressiveness, the techniques may dither the content item, which simulates continuous colors by using spatial dot patterns from a small set of colors. While the techniques may use any number of dithering algorithms, in one example the techniques use the Floyd-Steinberg dithering algorithm. The following table (Table 2) illustrates one example for creating an eight-color content item given the examples curves 202(1)-(M). The parameters may also be used to create a full-color image using the interpolation techniques discussed above.

TABLE 2

| | Pair a | | | Pair b | | |
|---|---|---|---|---|---|---|
| | (show at +25°, hide at +25°) | | | (hide at +25°, show at +25° | | |
| | R | G | B | R | G | B |
| Pixel Value | 1, 202 | 1, 190 | 1, 198 | 241, 255 | 202, 255 | 161, 255 |
| Observed | 77, 175 | 96, 166 | 113, 167 | 161, 168 | 163, 173 | 167, 168 |
| brightness | | | | | | |
| at +25° | | | | | | |
| Observed | 29, 30 | 35, 38 | 41, 41 | 3, 122 | 23, 138 | 11, 157 |
| brightness | | | | | | |
| at −25° | | | | | | |

FIG. 4 illustrates the example of creating eight-color content items on the right side of the figure. This includes, at 406, dithering at least a portion of pixel values of the first content item. Then, at 408, each pixel value of the first content item, including those pixel values that have been dithered, is mapped to one of the eight colors available from the first pairs of R, G, and B pixel values for the first content item. At 410, at least a portion of pixel values of the second content item are dithered. Thereafter, at 412, each pixel value of the second content item, including those pixel values that have been dithered, is then mapped to one of the eight colors available from the second pairs of pixel values in the R, G, and B color channels for the second content item.

Returning to FIG. 3, regardless of the process used to identify the pixel values for rendering at 314, the process 300 may render the first and second content items on the display at 316 by multiplexing the pixel values identified at 314. This multiplexing allows for concurrent display of both content items, while maintaining the pixel values for each.

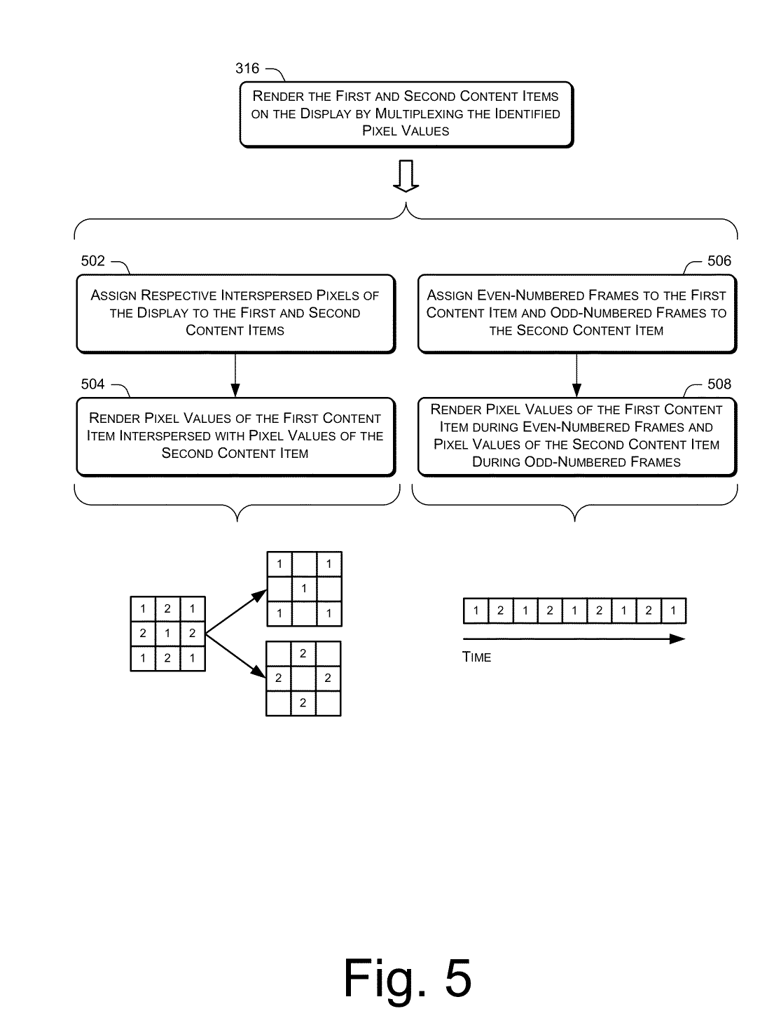

FIG. 5 illustrates two example techniques for multiplexing the first and second content items. This figure illustrates the use of spatial multiplexing on the left side and temporal multiplexing on the right. Addressing them in order, the spatial multiplexing includes assigning, at 502, respective interspersed pixels of the display to the first and second content items and, at 504, rendering the pixel values of the first content item interspersed with the pixel values of the second content item. In some instances, alternating pixels are assigned to the respective content items such that approximately half of the pixels of the display are assigned to the first content item and the other half are assigned to the second content item. Thus, when viewed from either of the two angles, one content item becomes visible while the other image becomes a uniform color (e.g., nearly black or white). As the two content items are interlaced on a fine spatial granularity (pixel-level), the viewer simply sees one continuous image.

Conversely, the process 300 may utilize temporal multiplexing, which interlaces the two content items in the time domain by displaying one content item (e.g., an image of a first video, a static image, etc.) at every even-numbered frame and the other content item (e.g., an image of a second video) at every odd-numbered frame (e.g., at 60 Hz). FIG. 5 illustrates one example of temporal multiplexing and includes, at 506, assigning these even-numbered frames to the first content item and the odd-numbered frames to the second content item. At 508, the process 300 accordingly renders the pixel values of the first content item during the even-numbered frames and the pixel values of the second content item during the odd-numbered frames. Thereafter, at either viewing angle the odd (or even) frames show one content item while the other frames are blank (e.g., nearly black or white). Human visual persistence, however, creates the perception of a single continuous image or video.

Both multiplexing methods may sacrifice resolution in one domain in exchange of maintaining the resolution in the other. Comparatively, spatial multiplexing may be more advantageous in some instances, since this technique does not introduce intrusive visual flickering and the full procedure is embedded into a single static image that can be shown without special programs.

One issue for both multiplexing methods is the reduction of image saturation, brightness, and/or contrast, as the image being shown is effectively blended with a nearly black or white background resulting from the hidden image. To address this issue, the rendering algorithm may intelligently determine if the available contrast becomes too low according to the brightness curves and, where applicable, may switch from rendering in “full-color” (e.g., via operations 402-404) to rendering in eight-color dithering (e.g., via operations 406-412) to compensate for the loss of contrast and/or saturation.

### Example Computing Device

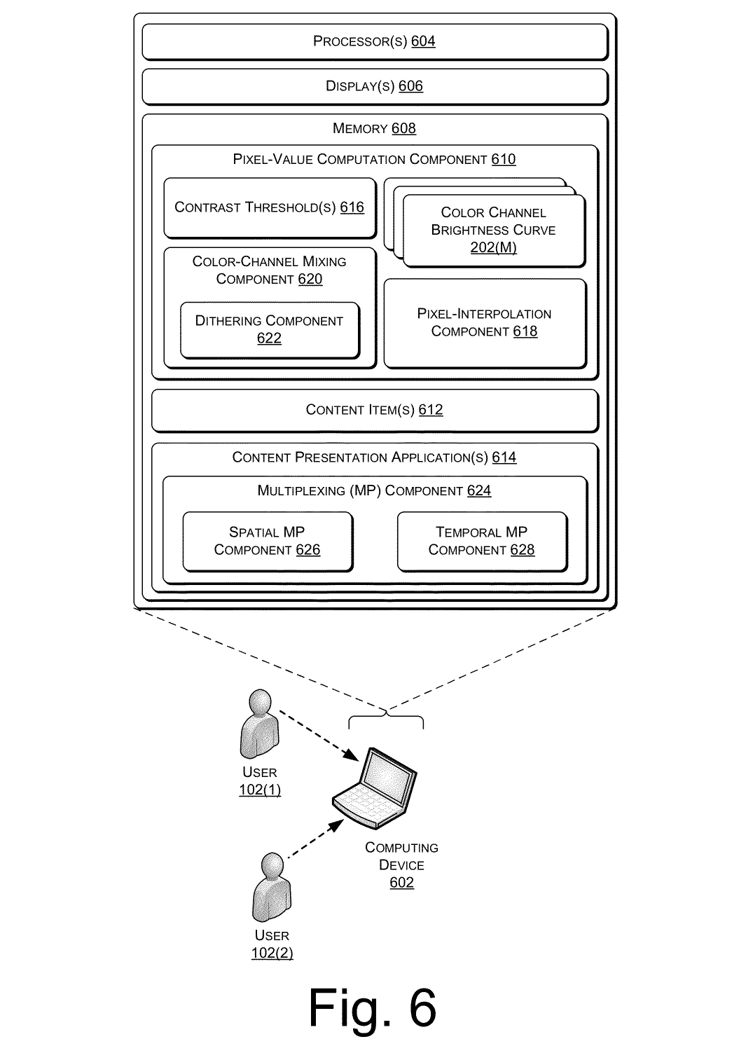

FIG. 6 illustrates several example components that may reside on a computing device 602 for computing pixel values to enable simultaneously rendering of multiple content items in the manner discussed above. While illustrated as a laptop computer, the computing device 602 may comprise any other sort of computing device, such as a desktop computer, a television, a portable music player, smartphone, ebook, a gaming console, a tablet or Slate computing device, a server, Surface Computer, or any other type computing device. Furthermore, in some instances a first computing device (e.g., a server) may compute the pixel values for simultaneously rendering the multiple content items, while a second computing device (e.g., a client computing device) may receive the content items (individually or in a single file) and may output the multiplexed items.

As illustrated, the example device 602 includes one or more processors 604, one or more displays 606, and memory 608. The memory 608 (and other memories described herein) may comprise computer-readable media. This computer-readable media includes, at least, two types of computer-readable media, namely computer storage media and communications media.

Computer storage media includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device.

In contrast, communication media may embody computer readable instructions, data structures, program modules, or other data in a modulated data signal, such as a carrier wave, or other transmission mechanism. As defined herein, computer storage media does not include communication media.

In this example, the memory 608 stores a pixel-value computation component 610, one or more content items 612, and one or more content presentation applications 614. While illustrated as a module stored in the memory 608 in this example, in other instances the pixel-value computation component (and/or other components described herein) may partially or entirely reside on the one or more processors 604, as may be the case in a “system on a chip” system.

In either instance, the pixel-value computation component 610 may store or otherwise have access to the color-channel brightness curves 202(1)-(M) discussed above, one or more contrast thresholds 616, a pixel-interpolation component 618, and a color-channel mixing component 620. Using the curves 202(1)-(M) and the predefined contrast threshold(s) 616, the component 610 may be configured to identify, for first and second content items respectively, the first and second optimal pairs of pixel values in the R, G, and B space described above. The component 610 may then store these values in association with the first and/or second content items for later rendering.

Thereafter, one or both of the pixel-interpolation component 618 and the color-channel mixing component 620 may be used to identify pixel values for rendering the first and second content items (either on the display 606 or on a display of another device). For instance, the pixel-interpolation component 618 may use equation (1), reproduced above, for identifying the pixel values for rendering on the display. Conversely, the color-mixing component 620 may render respective eight-color images as described above. As such, the component 620 may include a dithering component 622 for dithering the first and second content items prior to the rendering.

The content presentation applications 614, meanwhile, may comprise applications for rendering different types of content items. For instance, the applications 614 may include a multimedia player for rendering videos and the like. Additionally or alternatively, the applications 614 may include an image-viewer application for rendering still images. Still other applications are possible. In each instance, the applications 614 may include a multiplexing (MP) component 624 that includes a spatial MP component 626 and/or a temporal MP component 628. In some instances, a particular content presentation application 614 may render the first and second content items using the spatial MP component 626, while in other instances the application 614 may render the items using the temporal MP component 628. Meanwhile, in instances where the item to be rendered by the application comprises a static image that has already been spatially multiplexed (i.e., comprises two content items spatially multiplexed together), the content presentation application may comprise a standard image viewer configured to render the image without use a multiplexing component.

While FIG. 6 illustrates several example components that may reside on an example device, it is to be appreciated that the computing device 602 may include multiple other components, as one of ordinary skill in the art will appreciate. For instance, the memory 608 may store an operating system (OS), as well as numerous applications and data that run atop the OS. The device may also include one or more network interfaces for communicating with other devices over a network. In addition, the device may include one or more input/output (I/O) components for operating the respective devices, system busses, and the like.

### Measuring Brightness Curves

As described above, the color channel brightness curves 202(1)-(M) may be used to identify pixel-value pairs for hiding a content item at a particular angle and showing the content item at a different particular angle. Also as described above, these curves may vary amongst different display types, manufacturers, sizes, and the like. In some instances, these curves may be measured either using a camera or manually, as discussed below.

Because digital cameras are essentially multi-channel light sensor arrays, a digital camera may be used to measure the brightness of an LCD as viewed from different angles. In one example, the camera may be set a fixed distance from the LCD in a dark room with the automatic settings turned off. The camera may then be rotated in front of the LCD (or vice versa) both vertically and horizontally between, for example, −60° and +60° and at 10° intervals. At each rotation angle, the LCD displays a sequence of pure R, G, and B colors and covering the full range of pixel values (0-255) at thirty intervals for each of the three channels. Of course, any other angular ranges and pixel intervals may be used in other instances.

The camera may take a photo of each of these colors and may sample the captured color in the center of each photo as the observed brightness. Aggregating each of these samples results in color channel brightness curves, such as the curves illustrated in FIG. 2. In addition, curves between these curves may be interpolated.

In another implementation, a digital camera may be placed such that its lens resides directly against an LCD. This placement enables each pixel of the image sensor to essentially observe the LCD at a different angle, resulting in a wide and continuous range of both vertical and horizontal viewing angles. Therefore, a single photo may incorporate sufficient brightness information to generate two complete brightness curves (one vertical and one horizontal) for the color being displayed by the LCD. This technique may significantly increase the efficiency of the measurement and may also result in a very high resolution for the angles being measured for.

The above camera-based measurement method allows comprehensive recovery of the brightness curves, which may then be used to automatically extract optimal pixel color combinations for any viewing angles as described above. However, in some instances end users may desire to quickly find rendering parameters that work for one particular display device. That is, the users may wish to configure their current display device to render two different content items at two particular viewing angles. To provide an even lighter-weight way of calibrating the display device, an interactive program may aid a user in finding two approximate pixel color pairs for displaying dual views in two particular angles, using the user's naked eyes for judgment.

Examining the values in Table 1 and 2 reveals that for each of the three color channels, a pixel value equal to one (1) is among the optimal pixel value pair for showing content items at top views and hiding the content items in bottom views (Pair a). Similarly, a pixel value equal to 255 is among the optimal pair for the opposite case (Pair b) in each of the three color channels. Based on this empirical finding, one example technique is to fix these pixel values and then search for the opposite R, G, B values in the corresponding two pairs.

To do so, the user first looks at the LCD from the bottom viewing angle at which the user desires to view one of the two content items. The program may display a nearly black block on a nearly black background (e.g., both with RGB=(1, 1, 1)), such that the nearly black block is indistinguishable to the nearly black background. The user then uses a slider to increase the R value of the block until the user is able to distinguish the block from the background. The program records this R value for Pair a. This process may repeat for collecting G and B values for Pair a.

Similarly, for Pair b the user may look from the top viewing angle at which the user wishes to view the other content item. The program then renders a white block on a white background (e.g., both with RGB=(255, 255, 255)), after which the user decreases the R value of the block until the user is able to distinguish the block from the background. This process may repeat for G and B values, while recording the results as values for Pair b.

### Example Applications

Unlike previous multi-view display applications that require additional hardware, the techniques described herein may be incorporated into many daily application scenarios, given the wide existing usage of LCDs (e.g., TN LCDs). For instance, the techniques described herein may be incorporated into a movie player to enable the player to play two different videos simultaneously. As such, multiple people can enjoy different programs on the same display. Rendering different videos at different vertical angles may allow for family scenarios where adults and children may see different movies suited for their interest depending on their height. Hence, the viewing angles might not merely abstractly map to the content, but may instead convey semantic meanings.

In another example, the techniques described herein may be used within a gaming environment. Current video game players often rely on split-screen views when users play multi-player, first-person perspective games with co-located friends. This is not only an inefficient usage of the display, but also suffers from the deficiency of sharing private game information. The techniques described herein may allow two players to view a display implementing a multi-player game from different angles such that each player is able to view the entire display with a personalized view and without sharing the private game information.

In another example, two players facing each other may play a card game on a table computing device laid flat between them, similar to an interactive tabletop setup. In this example, each player is able to see their own cards in the area near themselves, whereas they can only see the back of the cards in their opponent's area. The region between the two may be public and, hence, visible to both. Further, a spectator sitting between the two players may be able to see cards from both players, as both players' views are visible (albeit with a lower contrast) from such an intermediate viewing angle. The described techniques thus effectively support three different views that inherently suit the three roles in the game.

Although the above example touches upon private information in a game, for more critical privacy applications (e.g., banking applications) the private information might only be visible to the user. In this scenario, the techniques may be used to show the information in a small angular range and not outside of this range. To serve this need, in one example the techniques may render an image that includes a random dot pattern that is shown outside of the small angular range. By surrounding the critical information with a random dots pattern that is perceived by users outside of the small viewing angle, the critical information is effectively hidden.

Applying this principle, a first content item in the form of the private information may be rendered, either as a “regular” image shown at each viewing angle or as an image perceivable at an angle_{show} and not outside of this angle. In either case, a second content item in the form of the random dots pattern may surround the private information and may be rendered with angle angle_{hide} equal to angle_{show} of the private information or equal to an angle at which the user would be positioned for reading the private information. As such, the private information is viewable from the angle_{show} or otherwise “in front” of the private information (as the random dot pattern disappears), but the random dots pattern is shown at each other viewing angle, thus obfuscating the private information. By doing so, the techniques may essentially swap the showing and hiding range.

In another scenario, the techniques may be used to present auto-stereoscopic images for enabling a three-dimensional (3D) viewing experience with naked eyes. This essentially turns a display (e.g., a TN LCD) into a 3D display when set to portrait orientation in some instances. In this regard, a pair of stereo images may be rendered, with the first image intended for a user's left eye and hidden from the user's right eye, and a second image intended the user's right eye and hidden to the user's left eye. Like other auto-stereoscopic displays, this 3D sensation may depend on the viewers' distance and position. To assist the user in finding an optimal distance for the 3D experience, the techniques may render “L” and “R” characters in the left-eye and right-eye views respectively, such that the user may move the device towards and/or away from the user's face until the user is able to see both letters with different eyes. At this point, in one example, the user may indicate to the application that they have reached the optimal point and the application may begin rendering a three-dimensional content item (e.g., still image, video, etc.)

In a final example, a display that is rendering two different content items utilizing the described techniques may be placed sideways near a mirror. This configuration may cause the first content item to be viewable on the display and the second content item to be viewable via the mirror, given the angle of reflection of the mirror. This scenario may, in effect, create a virtual second monitor and, therefore, a very cost efficient solution for extending real estate of the display.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims. For instance, although many of the examples are described in the context of an LCD, other types of displays that support the techniques described herein may also be used.

What is claimed is:

1. One or more computer-readable media storing computer-executable instructions that, when executed on one or more processors, cause the one or more processors to perform acts comprising:
determining, for a first content item to be rendered on a display, a viewing angle at which the first content item is to be hidden (angle_{hide(1)});
identifying a first pair of pixel values having a contrast that is less than a threshold at the angle_{hide (1)};
determining, for a second content item to be rendered on the display, a viewing angle at which the second content item is to be hidden (angle_{hide(2)});
identifying a second pair of pixel values having a contrast that is less than the threshold at the angle_{hide(2)}; and
rendering the first and second content items on the display by multiplexing pixel values that are based at least in part on the first and second pairs of pixel values.

2. One or more computer-readable media as recited in claim 1, wherein the display comprises a twisted nematic liquid crystal display (TN LCD).

3. One or more computer-readable media as recited in claim 1, the acts further comprising:
determining a viewing angle at which the first content item is to be shown (angle_{show(1)}); and
determining a viewing angle at which the second content item is to be shown (angle_{show(2)});
and wherein: (1) the identifying of the first pair of pixel values comprises identifying, from pairs of pixel values having a contrast that is less than the threshold at the angle_{hide(1)}, a pair of pixel values having a greatest contrast at the angle_{show(1)}, and (2) the identifying of the second pair of pixel values comprises identifying, from pairs of pixel values having a contrast that is less than the threshold at the angle_{hide(2)}, a pair of pixel values having a greatest contrast at the angle_{show(2)}.

4. One or more computer-readable media as recited in claim 1, wherein the identifying of the first and second pairs of pixel values comprises identifying the first and second pairs of pixel values for a red color channel, and the acts further comprising:
identifying a first pair of pixel values for a green color channel having a contrast that is less than the threshold at the angle_{hide(1)};
identifying a second pair of pixel values for the green color channel having a contrast that is less than the threshold at the angle_{hide(2)};
identifying a first pair of pixel values for a blue color channel having a contrast that is less than the threshold at the angle_{hide(1)}; and
identifying a second pair of pixel values for the blue color channel having a contrast that is less than the threshold at the angle_{hide(2)}.

5. One or more computer-readable media as recited in claim 4, wherein the rendering comprises rendering the first and second content items on the display by multiplexing pixel values that are based at least in part on the first and second pairs of pixel values in the red, green, and blue color channels.

6. One or more computer-readable media as recited in claim 4, the acts further comprising, prior to the rendering:
dithering at least a portion of pixel values of the first content item; and
dithering at least a portion of pixel values of the second content item.

7. One or more computer-readable media as recited in claim 6, the acts further comprising, prior to the rendering:
mapping each pixel value of the first content item to one of eight colors available from combinations of the first pairs of pixel values in the red, green, and blue color channels and rendering each mapped pixel value of the first content item on the display; and
mapping each pixel value of the second content item to one of the eight colors available from combinations of the second pairs of pixel values in the red, green, and blue color channels and rendering each mapped pixel value of the second content item on the display.

8. One or more computer-readable media as recited in claim 1, the acts further comprising, prior to the rendering:
mapping pixel values of the first content item into a range defined by the first pair of pixel values and rendering the mapped pixel values of the first content item on the display; and
mapping pixel values of the second content item into a range defined by the second pair of pixel values and rendering the mapped pixel values of the second content item on the display.

9. One or more computer-readable media as recited in claim 1, wherein the multiplexing comprises rendering, at a same time and at interspersed pixels of the display, pixel values that are based at least in part on the first pair of pixel values and pixel values that are based at least in part on the second pair of pixel values.

10. One or more computer-readable media as recited in claim 1, wherein the multiplexing comprises: (1) rendering, for even-numbered frames, pixel values that are based at least in part on the first pair of pixel values, and (2) rendering, for odd-numbered frames, pixel values that are based at least in part on the second pair of pixel values.

11. One or more computing devices comprising:
one or more processors; and
one or more components resident on or storing instructions executable by the one or more processors, the one or more components being configured to cause the one or more processors to perform acts comprising:
determining a first angle relative to a display at which a first content item is to be shown and a second content item is to be hidden;
determining a second angle relative to the display at which the first content item is to be hidden and the second content item is to be shown;
computing a first pair of pixel values having a contrast that is less than a first threshold at the first angle;
computing a second pair of pixel values having a contrast that is less than a second threshold at the second angle; and
storing the first and second pairs of pixel values in association with at least one of the first content item or the second content item.

12. One or more computing devices as recited in claim 11, wherein the first and second thresholds comprise the same or different thresholds.

13. One or more computing devices as recited in claim 11, wherein:
the computing of the first pair of pixel values further comprises computing, from pairs of pixel values having a contrast that is less than the first threshold at the first angle, a pair of pixel values having a greatest contrast at the first angle; and
the computing of the second pair of pixel values further comprises computing, from pairs of pixel values having a contrast that is less than the second threshold at the second angle, a pair of pixel values having a greatest contrast at the second angle.

14. One or more computing devices as recited in claim 11, wherein the computing of the first and second pairs of pixel values comprises computing the first and second pairs of pixel values in a red color channel, and the acts further comprising:
computing a first pair of pixel values in a green color channel having a contrast that is less than the first threshold at the first angle;
computing a second pair of pixel values in the green color channel having a contrast that is less than the second threshold at the second angle;
computing a first pair of pixel values in a blue color channel having a contrast that is less than the first threshold at the first angle; and
computing a second pair of pixel values in the blue color channel having a contrast that is less than the second threshold at the second angle.

15. One or more computing devices as recited in claim 11, the acts further comprising:
linearly interpolating pixel values of the first content item into a range of pixel values defined by the first pair of pixel values;
linearly interpolating pixel values of the second content item into a range of pixel values defined by the second pair of pixel values; and
storing the linearly interpolated pixel values of the first and second content items for rendering the first and second content items.

16. One or more computing devices as recited in claim 11, the acts further comprising rendering, based at least in part on the first and second pairs of pixel values, the first and second content items on the display such that the first content is shown at the first angle and hidden at the second angle and the second content item is hidden at the first angle and shown at the second angle.

17. One or more computing devices as recited in claim 16, wherein the rendering comprises at least one of: (1) spatially multiplexing the first content item and the second content item, or (2) temporally multiplexing the first content item and the second content item.

18. A computing device comprising:
a display;
one or more processors; and
one or more computer-readable media storing computer-executable instructions that, when executed on one or more processors, cause the one or more processors to render a content item comprising pixel values of varying colors and having a contrast that is perceivable on the display at a first angle relative to the display and not perceivable on the display at a second, different angle relative to the display.

19. A computing device as recited in claim 18, wherein:
the content item comprises a first content item; and
the instructions further cause the one or more processors to render a second, different content item comprising pixel values multiplexed on the display with the pixel values of the first content item, the pixel values of the second content item having a contrast that is perceivable on the display at the second angle relative to the display and not perceivable on the display at the first angle relative to the display.

20. A computing device as recited in claim 19, wherein: (1) the pixel values of the first and second content items are spatially multiplexed on the display such that a first portion of pixels of the display render the pixel values of the first content item and a second, different portion of the pixels of the display render the pixel values of the second content item, or (2) the first and second content items are temporally multiplexed on the display such that the pixel values of the first content item are rendered on the pixels of the display during even-numbered frames and the pixel values of the second content item are rendered on the pixels of the display during odd-numbered frames.
